(19) United States
(12) Patent Application Publication
(10) Pub. No.: US 2011/0010927 A1
(43) Pub. Date: Jan. 20, 2011

(54) Ignition coil for internal combustion engine and method of making the same

(75) Inventor: Katsunori AKIMOTO, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/923,382

(22) Filed: Sep. 17, 2010

Related U.S. Application Data
(62) Division of application No. 12/423,221, filed on Apr. 14, 2009.

(30) Foreign Application Priority Data
Apr. 15, 2008 (JP) 2008-106150
Apr. 10, 2009 (JP) 2009-095458

(51) Int. Cl. H01F 41/06

(52) U.S. Cl. 29/605

(57) ABSTRACT

An ignition coil for an internal combustion engine includes a primary coil formed by winding a primary winding a plurality of turns, a secondary coil formed by winding a secondary winding having a wire diameter of 30 to 100 μm a plurality of turns, and a resin compact which is impregnated into between the lines of the primary winding and between the lines of the secondary winding and which seals the primary coil and the secondary coil. The resin compact includes a filler in a range of 65 weight percent to 80 weight percent in order to limit development of an electric tree in the resin compact, and the filler is composed of 60 weight percent or more spherical silica and 40 weight percent or less crushed silica.

### CROSS REFERENCE TO RELATED APPLICATION

This application is a Division of application Ser. No. 12/423,221, filed Apr. 14, 2009, which claims priority from and is based on Japanese Patent Application No. 2008-106150 filed on Apr. 15, 2008 and Japanese Patent Application No. 2009-095458 filed on Apr. 10, 2009, the contents of each of which are hereby incorporated by reference.

### BACKGROUND OF THE INVENTION

1. Field of the Invention

The present invention relates to an ignition coil for an internal combustion engine that generates a voltage applied to an ignition plug in the engine and a method of making the ignition coil.

2. Description of Related Art

An ignition coil for an internal combustion engine (hereafter referred to simply as a ‘ignition coil’) is for applying high voltage to an ignition plug attached to the engine so as to ignite fuel-air mixture, and is formed by sealing a primary coil, secondary coil, and the like with a resin compact made of thermosetting resin or the like (see, for example, JP-A-11-26267).

Conventionally, as a method of sealing the primary coil and secondary coil in the resin compact, after a housing that contains components of an ignition coil such as the primary coil and secondary coil is set in a furnace, and the inside of the furnace is put into a vacuum or atmospheric state, a precursor of the resin compact in a liquid state is dropped into an opening of the housing so as to fill the inside of the housing with the precursor. The method of heating the resin to be hardened under the atmospheric pressure environment after the above process, so as to seal and adhere the primary coil, secondary coil and the like with the resin compact, is known.

As the resin compact, one to which silica, which is known to limit development of an electric tree in the resin compact, is added to epoxy resin as a filler is widely used, and In producing an ignition coil using such a resin compact including silica by the above-described production method, to sufficiently impregnate the precursor in liquid form between the lines of a primary winding and between the lines of a secondary winding, more specifically, not to generate a void, which accelerates the development of the electric tree, between the above lines, a contained amount of silica for the resin compact is adjusted in order that viscosity of the precursor is smaller than 50 poises with about 50 weight percent for the weight of the resin compact being an upper limit of a contained amount of silica.

Recent years, in a supercharging and lean-burn gasoline direct-injection engine as an environment-friendly engine to cope with a fuel-efficient and low-pollution vehicle, there are growing concerns about reduced ignitionability of the ignition coil in accordance with use of high compression ratio and high EGR (Exhaust Gas Recirculation), and as a means for preventing this reduced ignitionability, an ignition coil having high output (generated voltage, spark discharge energy, etc.) is required. With such a demand for higher output on the ignition coil, discharge voltage of the secondary coil needs to be up to about 40 kV.

However, in order to ensure a lifetime of such a high-output ignition coil against high withstand voltage, to obtain an insulation distance by increasing a size of the housing in a space above a plug hole or cylinder head to secure the high withstand voltage lifetime is not preferable from the standpoint of ensuring a space in a hood under the pedestrian protection law and the like.

Accordingly, to sufficiently secure the high withstand voltage lifetime of the high-output ignition coil without increasing a size of the ignition coil, it may be possible to make a contained amount of silica, which is contained in epoxy resin and limits the development of the electric tree, larger than 50 weight percent. However, as described above, when a contained amount of silica for the resin compact is 50 weight percent or above, viscosity of the resin compact increases, so that the resin compact is not sufficiently impregnated between the lines of the primary winding and secondary winding. As a result, a void is produced, and because of the void, the high withstand voltage lifetime may be conversely reduced, more specifically, a lifetime against corona discharge (hereafter referred to as a corona life) may be reduced. Therefore, in a high-output ignition coil, it has been difficult to employ the resin compact of a contained amount of silica being 50 weight percent or above.

### SUMMARY OF THE INVENTION

The present invention is made in view of these problems, and an objective of the present invention is to provide an ignition coil having a better corona life than ever before and a method of making the ignition coil.

As one example of the present invention, in an ignition coil for an internal combustion engine including a primary coil formed by winding a primary winding a plurality of turns, a secondary coil formed by winding a secondary winding having a wire diameter of 30 to 100 μm a plurality of turns, and a resin compact which is impregnated into between the lines of the primary winding and between the lines of the secondary winding and which seals the primary coil and the secondary coil, the resin compact includes a filler in a range of 65 weight percent to 80 weight percent, which has 60 weight percent or more spherical silica and 40% weight percent or less crushed silica in order to limit development of an electric tree in the resin compact.

In the above manner, by sealing the primary coil and the secondary coil with the resin compact including silica in a range of 65 weight percent to 80 weight percent, particles of the filler which account for a weight fraction of a range of 65 percent to 80 percent in the resin compact serve as a significant block against development of an electric tree forming an insulation breakdown passage so as to limit the development of the electric tree, thereby improving a corona life.

Moreover, by composing a filler of 0 weight percent or more spherical silica and 40 weight percent or less crushed silica, variation in the corona life of the ignition coil is considerably improved and the ignition coil having a desired corona life is reliably obtained. It is well known that silica, which is generally included in the resin compact as a filler, is roughly divided between spherical silica and crushed silica based on their particle configurations.

By using the above-described resin compact, high voltage-resisting properties in proximity to the secondary coil, in which a corona discharge is particularly easily generated, are improved, so that an ignition coil having a long corona life is obtained.

For instance, a linear expansion coefficient of the resin compact is 10×10⁻⁶ to 27×10⁻⁶/° C. By using the resin compact having such a linear expansion coefficient, a difference between a linear expansion coefficient of a primary coil, a secondary coil and the like which constitute an ignition coil and the linear expansion coefficient of the resin compact becomes small. Accordingly, influence of a cold and hot cycle upon the ignition coil under the environment of its usage is mitigated. Thus, crack resistance of the resin compact improves, so that an ignition coil having a long corona life is obtained.

Another example of the present invention is a method for making an ignition coil for an internal combustion engine including a primary coil formed by winding a primary winding a plurality of turns, a secondary coil formed by winding a secondary winding having a wire diameter of 30 to 100 μm a plurality of turns, and a resin compact which is impregnated into between the lines of the primary winding and between the lines of the secondary winding and which seals the primary coil and the secondary coil, the resin compact having a filler in a range of 65 weight percent to 80 weight percent. It is a method for making an ignition coil for an internal combustion engine, which is characterized in that the method includes a decompressing process for putting the inside of an accommodating body accommodating the primary coil and the secondary coil into a state of lower pressure than an atmospheric pressure, a cast molding process for sealing the primary coil and the secondary coil with a precursor of the resin compact, and a pressurizing process for pressurizing the precursor.

More specifically, in forming the resin compact, by sealing the primary coil and the secondary coil with the precursor of the resin compact when the accommodating body in which the primary coil and the secondary coil are accommodated is in a low pressure state, and then by pressurizing the precursor, the above precursor is sufficiently impregnated into between the lines of the primary winding or the secondary winding. Consequently, the ignition coil having a satisfactory corona life is produced.

For instance, the filler included in the resin compact consists of spherical silica and crushed silica, and the filler includes 60 weight percent or more spherical silica and 40 weight percent or less crushed silica. Since the spherical silica has fewer acute-angled portions than the crushed silica, electric field concentration does not occur with ease or in other words, an electric tree does not develop easily on an interface between the resin compact and the filler.

Moreover, because the spherical silica has fewer acute-angled portions than the crushed silica, stress (hereinafter referred to as resin stress) on the interface between the resin compact and the filler is difficult to generate, so that a crack is not generated easily. Therefore, a possibility that an air layer produced by the crack may reduce the corona life of the ignition coil is small under the environment of usage of the ignition coil. Hence, variation of a corona life for every ignition coil is limited, so that the ignition coil having a satisfactory corona life is produced.

Furthermore, by using the resin compact including 60 weight percent or more spherical silica based on a knowledge that the spherical silica has a greater effect of reducing viscosity of the resin compact than the crushed silica, spaces between the lines of the primary winding or the secondary winding are easily filled with the resin compact, so that a void is not generated with ease. Accordingly, an ignition coil having a long corona life is obtained.

For example, in the pressurizing process, the precursor is pressurized at a pressure range of 2 MPa to 8 MPa. When the pressure to apply is lower than 2 MPa in the pressurizing process, the above-described precursor is not sufficiently impregnated into between the lines of the primary winding and between the lines of the secondary winding, so that the void may remain. On the other hand, when the above pressure is higher than 8 MPa, the ignition coil may suffer adverse effects, such as positional misalignment of components of the ignition coil. Thus, it is desirable that the precursor should be sufficiently impregnated into between the lines of the primary winding and between the lines of the secondary winding by pressurizing the precursor at a pressure range of 2 MPa to 8 MPa in the pressurizing process.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic view of a longitudinal section illustrating an ignition coil;

FIG. 2 is a characteristic diagram illustrating a relationship between a filler content and a corona life of the ignition coil;

FIG. 3 is a characteristic diagram illustrating a relationship between the corona life of the ignition coil and electric field intensity generated in the ignition coil;

FIG. 4 is a characteristic diagram illustrating a relationship between the filler content and a linear expansion coefficient of a resin material;

FIG. 5 is a characteristic diagram illustrating a relationship between content ratios of spherical silica and crushed silica and the corona life;

FIG. 6 is a schematic view illustrating a test condition of FIG. 5;

FIG. 7A is a comparative diagram between occurrence tendencies to electric field concentration using a simple model of the spherical silica and crushed silica;

FIG. 7B is a comparative diagram between resin stresses using a simple model of the spherical silica and crushed silica;

FIG. 8 is a schematic view illustrating a decompressing process;

FIG. 9 is a schematic view illustrating a cast molding process;

FIG. 10 is a schematic view illustrating a pressurizing process; and

FIG. 11 is a schematic view illustrating a modification of structure of the ignition coil.

### DETAILED DESCRIPTION OF THE INVENTION

Embodiments of the present invention are described below with reference to drawings.

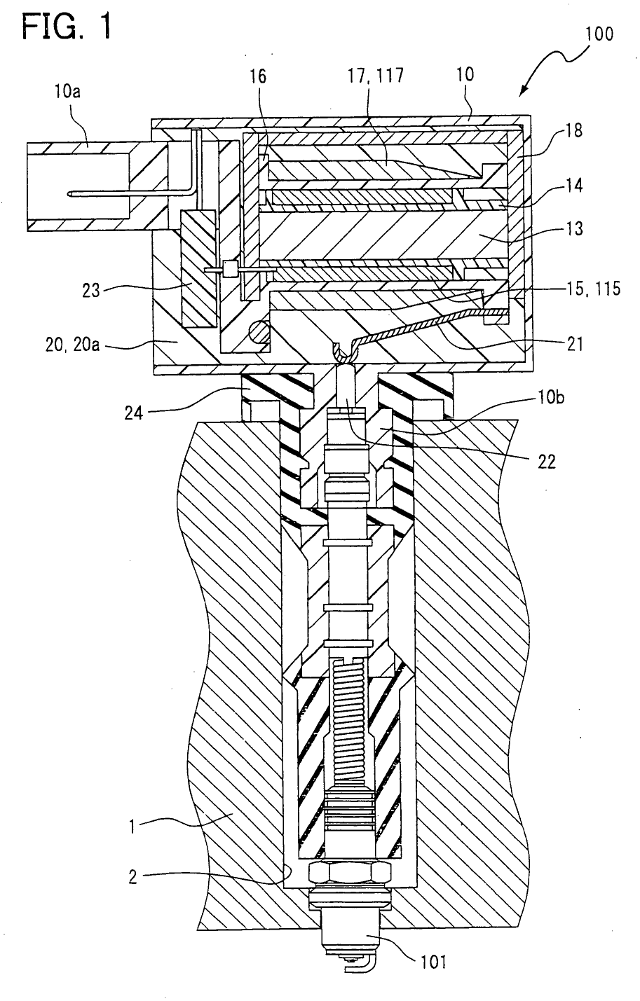

First, a basic constitution of an ignition coil 100 according to the present invention is explained. In addition, FIG. 1 is a schematic view of a longitudinal section of the ignition coil 100.

### (Basic Constitution)

A housing 10 is made of hard resin such as PBT, and has a rectangular box shape having a larger bottom face than a cross-sectional area of a plug hole 2 of an engine head 1. The housing 10 is fixed to the outside of an opening of the plug hole 2. Furthermore, a connector part 10a projecting outward from the housing 10 is integrally formed respectively on a side wall of the housing 10. The connector part 10a serves to electrically connect an external power (not shown) and an igniter 23. Additionally, a cylindrical member 10b projecting from the housing 10 to the plug hole 2 side is integrally formed on a bottom wall of the housing 10 opposed to the engine head 1.

As shown in FIG. 1, a center core 13, a primary spool 14, a primary coil 15, a secondary spool 16, and a secondary coil 17 are accommodated in the housing 10, and moreover, a peripheral core 18 is provided outside the housing 10.

The center core 13 is formed by stacking magnetic materials, and has a cylindrical shape as a whole. The center core 13 is disposed such that its axial direction is generally perpendicular to an axial direction of the plug hole 2.

The peripheral core 18 is formed by stacking magnetic materials, and has a box shape which opens toward the plug hole 2 as a whole. A pair of opposing side surfaces of the peripheral core 18 is opposed to both end surfaces of the center core 13, and as a result, the center core 13 and the peripheral core 18 constitute a closed magnetic circuit which limits a loss of magnetic energy.

The primary spool 14 is made of hard resin such as PP and PE, and is disposed generally concentrically with the center core 13 on an outer circumferential side of the center core 13. The primary coil 15 is formed by winding a primary winding 115 having a round cross section around a bobbin-shaped primary spool 14. In addition, the primary coil 15 is formed by winding 100 to 230 turns a copper wire having a diameter of 0.3 to 0.8 mm.

The secondary spool 16 is made of hard resin such as PP and PE, and is disposed generally concentrically with the center core 13 on an outer circumferential side of the primary coil 15. The secondary coil 17 is formed by winding a secondary winding 117 having a round cross section around the bobbin-shaped secondary spool 18. Additionally, the secondary coil 17 is formed by winding 10000 to 20000 turns a copper wire having a diameter in a range of 30 μm to 100 μm, more preferably, in a range of 40 to 50 μm, using a winding method such as diagonally winding.

The inside of the housing 10 is filled with a resin material 20. The resin material 20 exists between the secondary coil 17 and the housing 10 so as to provide electrical isolation therebetween. As well, the resin material 20 also exists between the primary coil 15 and the secondary coils 17 so as to provide electrical isolation therebetween.

As shown in FIG. 1, a sealing member 24 is made of a rubber material, and has a generally cylindrical shape as a whole. The sealing member 24 is disposed between an outer circumferential surface of the cylindrical member 10b, the bottom wall of the housing 10 and an upper surface of the engine head 1 so as to seal the opening of the plug hole 2. The secondary terminal 22 is disposed on an inner circumferential side of the cylindrical member 10b, and a winding end portion of a self welding wire which constitutes the secondary coil 17 is electrically connected to a high-voltage terminal 22 via a metal terminal 21.

In the above-described constitution, when the igniter 23 incorporating a switching element stops an electric current flowing through the primary coil 15, in response to a signal from an engine control unit (not shown), a high voltage of about 40 kV is generated in the secondary coil 17 due to a mutual induction effect between the primary and secondary coils 15, 17. By this means, the high voltage generated in the secondary coil 17 is conducted to the ignition plug 101 via the high-voltage terminal 22 and the like to generate a spark discharge at a front end of the ignition plug 101.

### (Characteristic Constitution)

As described above, the inside of the housing 10 is filled with the resin material 20, and the center core 13, the primary spool 14, the primary coil 15, the secondary spool 16, the secondary coil 17, the peripheral core 18, and the igniter 23 are sealed and isolated with the resin material 20.

The resin material 20 contains 75 weight percent spherical silica (not shown) as a filler in a thermosetting resin. In addition, because performance of, for example, adhesive properties with the center core 13, the primary spool 14, the primary coil 15, the secondary spool 16, the secondary coil 17, the peripheral core 18, and the igniter 23, and cost reduction are demanded of the thermosetting resin in addition to insulation properties, it is preferable to use epoxy resin for the thermosetting resin. The resin material 20 becomes vitrified without fluidity at temperature lower than a glass transition point Tg, and becomes rubber-like with fluidity at temperature higher than the glass transition point Tg. Additionally, both are different only in their states, but have the same compositions.

In order to distinguish both, the vitrified resin material 20 is hereafter referred to as a resin compact 20a, and the rubber-like resin material 20 is referred to as a precursor 20b. In addition, in the manufacturing process of the ignition coil 100, by injecting the precursor 20b into the inside of the housing 10 and then heating it, the precursor 20b is transformed into the resin compact 20a. Accordingly, in the ignition coil 100 as an end product, the resin material 20 exists in a state of the resin compact 20a.

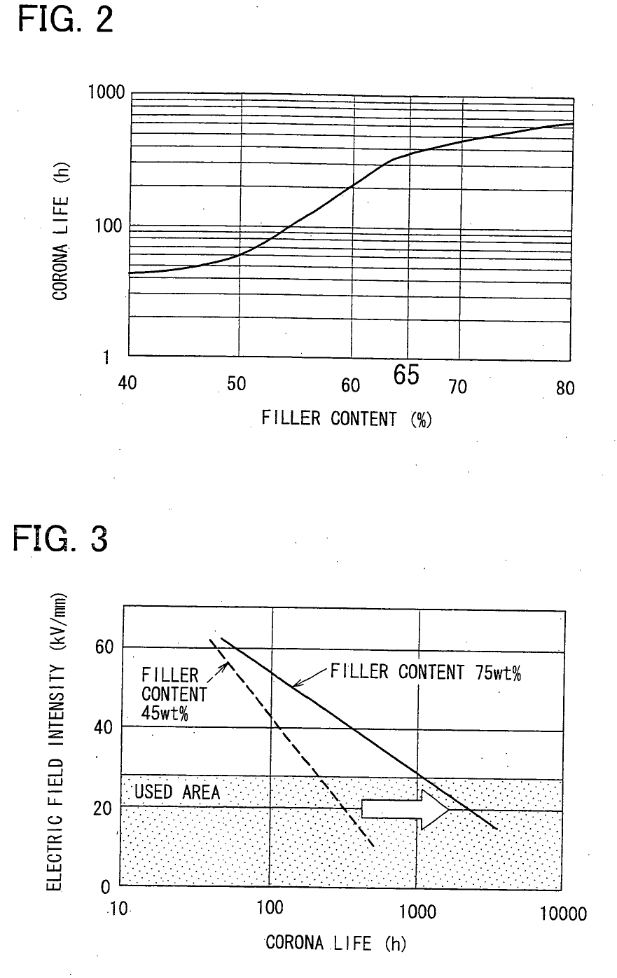

FIG. 2 is a characteristic diagram illustrating a corona life (withstand voltage life) of the ignition coil 100 when a contained amount of the filler made of 100 percent spherical silica is variously changed with the resin compact 20a being 100 weight percent, and FIG. 3 is a characteristic diagram illustrating a relationship between electric field intensity (kV/mm) generated when the ignition coil 100 is used and the corona life (h). With reference to FIG. 2, when the above filler in a range of 65 weight percent to 80 weight percent is contained in the resin compact 20a, the corona life of the resin compact 20a has a good value of 370 hours or longer. This is because the spherical silica in the resin compact 20a serves as development resistance against an electric tree, which grows and develops due to a corona discharge generated from the high-voltage side of the ignition coil 100, more specifically, for example, from the high-voltage side of the secondary coil 17 toward the peripheral core 18, to limit the development of the electric tree.

As well, as shown in FIG. 3, at, for example, the electric field intensity of 20 kV/mm which is an actual used area of the ignition coil 100, it is verified by experiment that the corona life of the ignition coil 100 of the present embodiment indicated by a continuous line improves by about a few thousand hours as compared to a conventional ignition coil indicated by a short dashes line. In addition, the experimental result in FIG. 3 illustrates a comparison between a conventional product of 45 weight percent filler content in the resin compact 20a and the present invention of 75 weight percent filler content in the resin compact 20a, and the experiments are performed under entirely the same conditions of sizes of the ignition coils, compositions of the fillers and their components. Additionally, in FIG. 3, the filler consists of 100 percent spherical silica in the resin compact 20a of the present invention, and on the other hand, the filler of the conventional product consists of 10 weight percent spherical silica and 90 weight percent crushed silica. A difference between the spherical silica and crushed silica is that the spherical silica has an approximately spherical shape by melting it at high temperature to be formed in a spherical shape, and on the other hand, the crushed silica has an angulated shape having an acute-angled edge because it is formed through mechanical crush.

As shown in FIG. 3, using a resin compact including the filler in a range of 65 weight percent to 80 weight percent in the resin compact 20a, the ignition coil 100 having a far better corona life than ever before is obtained. The electric tree is an arborescens insulation breakdown passage caused by treeing breakdown.

Additionally, characteristics of the resin material 20 such as adhesive properties are lost because, when the filler content exceeds 80 weight percent, a base material in the resin material 20, for example, an epoxy group decreases. Thus, the resin material 20 is unsuitable.

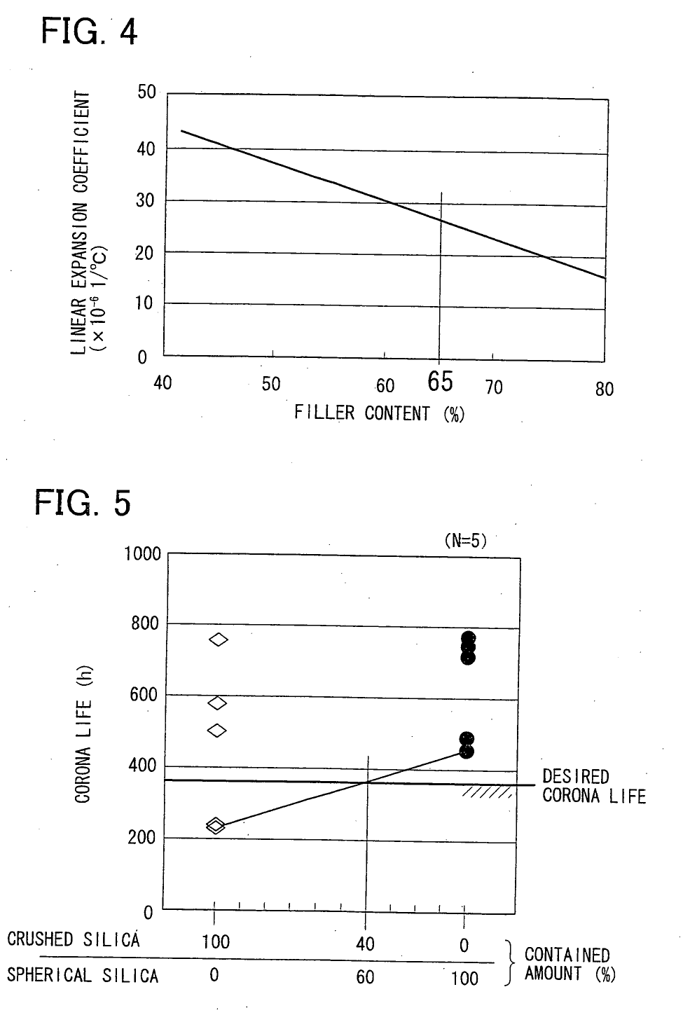

FIG. 4 is a characteristic diagram illustrating a relationship between the filler content and a linear expansion coefficient of the resin material 20. As shown in FIG. 4, as a weight ratio of silica included in the resin compact 20a is increased more, the linear expansion coefficient of the resin compact 20a further decreases linearly. Among these, the linear expansion coefficient of the resin compact 20a including the filler, which consists of 100 weight percent spherical silica, in its range of 65 weight percent to 80 weight percent has 17 to 27 (×10⁻⁶/° C.), which is a very small value for the resin material 20. Since a linear expansion coefficient of each metallic component member of the ignition coil 100, such as the primary coil 15, the secondary coil 17, the center core 13, and the peripheral core 18 is about 10 to 15 (×10⁻⁶/° C.), a difference between the linear expansion coefficients of these component members and the linear expansion coefficient of the resin compact 20a is very small.

Accordingly, all the components of the ignition coil 100 expand and contract generally integrally due to a cold heat stress generated under the environment of usage of the ignition coil 100. Therefore, a stress applied between the resin compact 20a and the above metallic component member decreases, so that generation of a crack of stress origin in the resin compact 20a is limited. Because the crack, which is an air layer, promotes the development of the electric tree, the crack is difficult to generate in the resin compact 20a by using the above resin compact 20a, so that the development of the electric tree is limited. As a result, the corona life of the ignition coil 100 is even more prolonged. Thus, it is specified that the above filler content is 65 weight percent or above in order to reduce the linear expansion coefficient of the resin compact 20a to improve the corona life of the ignition coil 100. In addition, in FIG. 3, the resin compact 20a including 75 weight percent filler is when the filler is constituted of 100 weight percent spherical silica. It is verified by experiment that also when a weight ratio of spherical silica is varied between 60 weight percent and 100 weight percent, in other words, also when 40 weight percent crushed silica or less is included in the filler, similar behavior is displayed to some degree or another.

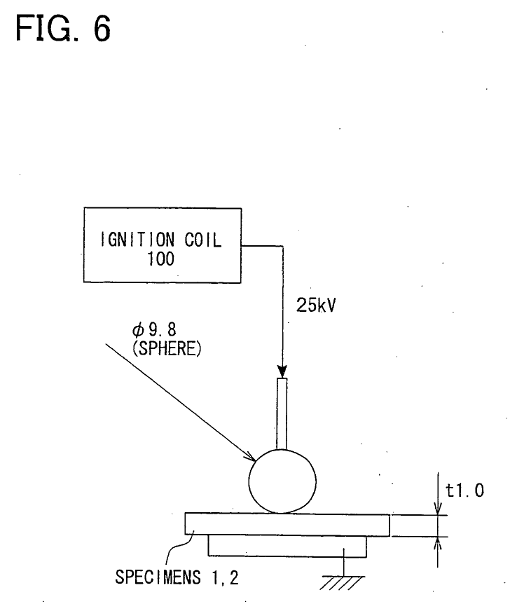

A plate-shaped specimen 1 (containing 100 weight percent spherical silica with respect to the filler) of the resin compact 20a having a similar composition to the present embodiment, and a specimen 2 having an identical shape with the specimen 1 and containing 100 weight percent crushed silica with respect to the filler of the resin compact 20a are prepared. FIG. 5 is a diagram that compares corona lives of the specimen 1, 2. A test result (the number of times of the test is 5) when a steel ball having a diameter of 10 mm is pressed on the specimens 1, 2 each of which having a thickness of about 1.0 mm and the ignition coil 100 is connected to the steel ball to apply a voltage of 25 kV to the specimens 1, 2 at a frequency of 100 Hz, as a test method is illustrated in FIG. 6.

A vertical axis of FIG. 5 indicates a corona life (h), and a horizontal axis of FIG. 5 indicates each weight ratio (%) of the spherical silica and crushed silica included in the resin compact 20a. As shown in FIG. 5, a corona life of the specimen 1 (100 weight percent spherical silica) falls within a range of about 430 hours to 790 hours, and on the other hand, a corona life of the specimen 2 (100 weight percent crushed silica) varies widely in a range of about 220 hours to 790 hours. More specifically, when the specimen 1 and specimen 2 are compared, although a difference between maximal values of the corona lives of the specimen 1 and specimen 2 is small, the corona life of the specimen 2 varies widely as compared to the specimen 1. The corona life of the specimen 2 considerably falls below 370 hours, which is a desired corona life as the ignition coil 100, due to the production tolerance of the resin compact 20a, and an ignition coil which does not have a desired corona life may be produced. Accordingly, in order to solve such a problem to optimize a weight ratio between the spherical silica and crushed silica, a minimum value of the corona life of the specimen 1 and a minimum value of the corona life of the specimen 2 are connected with a straight line in the above test result, and an intersecting point of the straight line and a lower limit (370 hours) of the desired corona life is obtained. Then, it is concluded that, based on this intersecting point, use of a filler having spherical silica in a range of 60 weight percent to 100 weight percent and crushed silica in a range of 0 weight percent to 40 weight percent is suitable to produce the ignition coil 100 having a desired corona life.

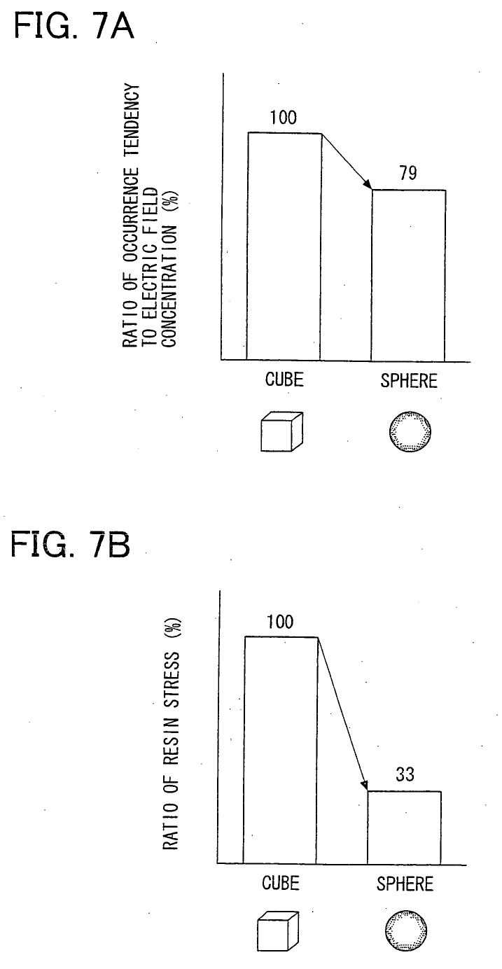

FIG. 7A and FIG. 7B are diagrams illustrating a comparison using a simple model between a filler composed of 100 weight percent spherical silica and a filler composed of 100 weight percent crushed silica with respect to an occurrence tendency to electric field concentration and a resin stress. The simple model simulates the filler using 100 weight percent spherical silica as a sphere and the filler using 100 weight percent crushed silica as a cube. In addition, the results of FIG. 7A and FIG. 7B are calculated using a software ANSYS produced by ANSYS Japan Corp.

As shown in FIG. 7A, as for the spherical silica, the occurrence tendency to electric field concentration is low by about 20% compared with the crushed silica. It would appear that this is because the spherical silica has fewer acute-angled portions than the crushed silica. More specifically, it is believed that, because the electric field concentration is difficult to generate in the spherical silica compared with the crushed silica, the development of the electric tree slows down and the corona life improves, so that a corona life for every ignition coil is stabilized in a favorable range.

Furthermore, as shown in FIG. 7B, the resin stress of the spherical silica is about 70% smaller than the crushed silica. It is contemplated that this is because, similar to the above description, the spherical silica has much fewer acute-angled portions than the crushed silica. Since the resin stress is difficult to generate in the spherical silica compared with the crushed silica, the resin stress on an interface between the resin compact 20a and the filler is difficult to generate, so that a crack is difficult to generate. Accordingly, there is a small possibility that an air layer produced by the crack decreases the corona life of the ignition coil 100 under the environment of usage of the ignition coil 100, and dispersion of a corona life for every ignition coil 100 is limited, so that the ignition coil 100 having a satisfactory corona life is produced.

Additionally, the resin compact 20a including the spherical silica has lower viscosity at temperature of the glass transition point Tg or below than the resin compact 20a including the crushed silica. Thus, in a cast molding process and a pressurizing process of the resin material 20, which are described in greater detail hereinafter, the resin compact 20a is easily impregnated between the lines of the secondary winding 117 of the secondary coil 17 to heighten insulation properties and withstand voltage of the ignition coil 100.

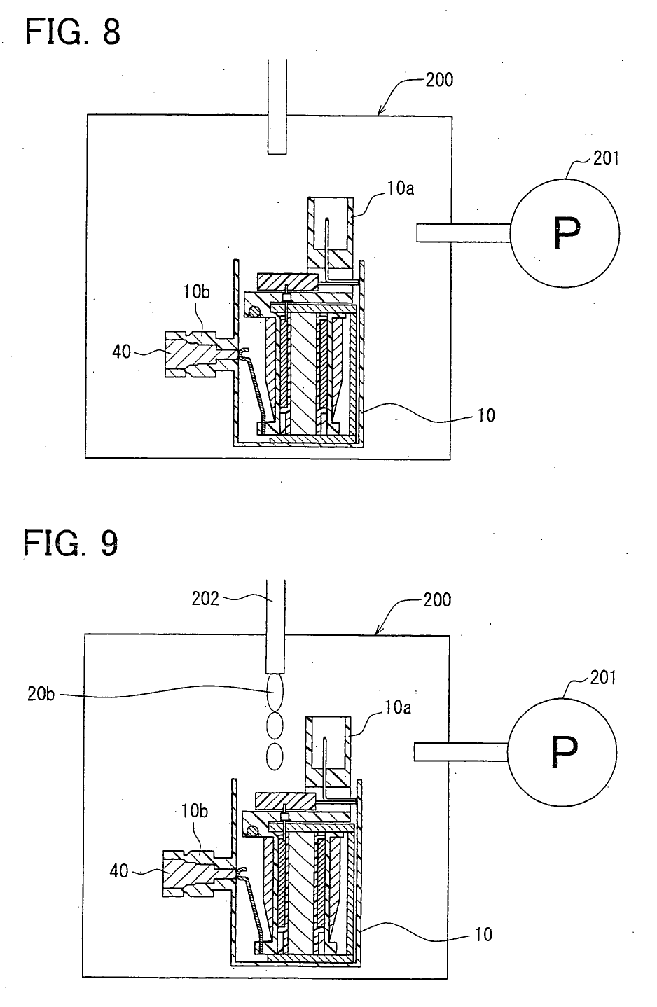

A method for manufacturing the above-described ignition coil 100 is explained in detail below. In the manufacturing method, a process, in which the inside of the housing 10 is filled up with the precursor 20b and which is the most characteristic manufacturing process in the present embodiment, is described in detail with reference to FIG. 8 to FIG. 10.

First of all, with the center core 13, the primary spool 14, the primary coil 15, the secondary spool 16, the secondary coil 17, the peripheral core 18, and the igniter 23 positioned in the housing 10 as shown in FIG. 8, the housing 10 is disposed in a furnace 200 which forms an airtight space. Meanwhile, only a portion of the side wall of the housing 10 where the connector area 10a projects opens, and the housing 10 is arranged in the furnace 200 such that the precursor 20b, which is described in greater detail hereinafter, is injected through this opening. Moreover, a sealing plug 40, such as a terminal, is inserted into the opening of the cylindrical member 10b to close the opening. The furnace 200 corresponds to an accommodating body described in claims.

Next, a decompressing process is performed to decompress the inside of the furnace 200 to, for example, 3 to 4 torr using a pressure control unit 201. In addition, in the present embodiment, the inside of the furnace 200 is decompressed to 3 to 4 torr in view of a period for vacuuming, but by spending a sufficient period, the inside of the furnace 200 may be turned into a highly vacuum state of, for example, about 1 torr.

In the cast molding process shown in FIG. 9 after completion of the decompressing process, the precursor 20b is injected into the housing 10 through a cylindrical nozzle 202 so as to seal the center core 13, the primary spool 14, the primary coil 15, the secondary spool 16, the secondary coil 17, the peripheral core 18, and the igniter 23 in the housing 10. At this point, the precursor 20b includes 70 weight percent spherical silica. The precursor 20b including more spherical silica has lower viscosity of the precursor 20b than the precursor 20b including more crushed silica. Nevertheless, the filler of the present embodiment including as much as 75 weight percent spherical silica with respect to the precursor 20b has high viscosity of 50 poises or above, so that the resin compact 20a is not sufficiently impregnated between the lines of the secondary winding 117 and a void (not shown) resulting from bubbles may remain inside the housing 10.

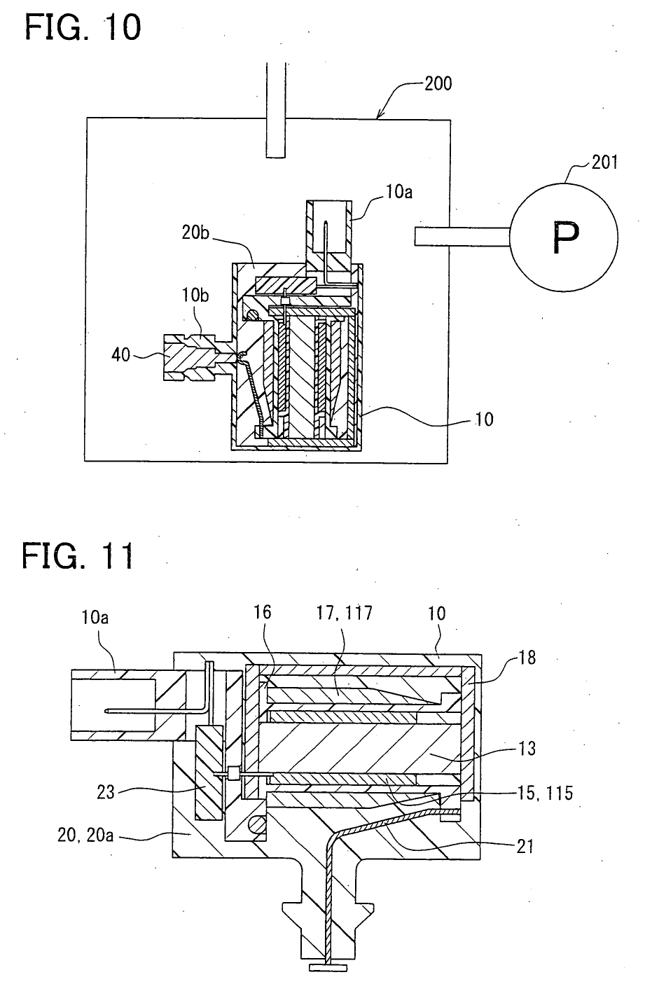

Accordingly, as shown in FIG. 10, in the pressurizing process that follows, compressed air is introduced into the furnace 200 in a low pressure state using the pressure control unit 201 so as to turn the inside of the furnace 200 into a high pressure state of, for example, 5 MPa. As a result, the precursor 20b that is injected into the housing 10 is pressurized, so that the void in an extremely low pressure state, which may remain in the housing 10, is reduced to an extremely small size or caused to disappear. In this manner, by eliminating the void, which accelerates or promotes the development of the electric tree, the corona life of the ignition coil 100 which is to be produced improves.

In increasing a pressure in the furnace 200 in the pressurizing process, the void cannot be reduced or made to disappear when the pressure is smaller than 2 MPa. On the other hand, when the pressure is larger than 8 MPa, the center core 13, the primary spool 14, the primary coil 15, the secondary spool 16, the secondary coil 17, the peripheral core 18, and the igniter 23, which are attached to the inside of the housing 10, are positionally misaligned. Accordingly, it is preferable that the pressure to apply should be 2 to 8 MPa or in particular, 5 MPa in the pressurizing process.

Moreover, although an period for impregnation of the precursor 20b into the secondary winding 117 and the like has conventionally required one hour or more, in the present embodiment, the impregnation period is significantly reduced to five minutes or less as a result of the above pressurizing process, and this is of advantage also in improving productivity of the ignition coil 100.

After the completion of the pressurizing process, the precursor 20b is injected again to compensate a decrease of volume of the precursor 20b because of the pressurization, and then the precursor 20b is heated and hardened to be the vitrified resin compact 20a. Accordingly, the ignition coil 100 is completed by removing the sealing plug 40.

Only by the above-described production method, the resin compact 20a including the filler in a range of 65 weight percent to 80 weight percent, which is made of the spherical silica, is impregnated between the lines of the primary conductive wire 115 or secondary conductive wire 117, so that the ignition coil 100 having a good corona life is produced.

In addition, in the above pressurizing process, the precursor 20b is pressurized by introducing compressed air into the furnace 200. However, as long as the process is a production method whereby the precursor 20b is sufficiently impregnated into the secondary winding 117 and the like, methods other than the above production method may be employed.

More specifically, for example, after a metal forming die (not shown) is prepared as the accommodating body described in claims and a primary coil and secondary coil are accommodated in the forming die, to go through a decompressing process, a pressurization method whereby pressure is applied at the time of injection of precursor 20b by injection molding, for example, may be adopted. Since the cast molding process and the pressurizing process described in claims are performed at the same time through this injection molding, a period required for production of the ignition coil 100 is shortened. When the precursor 20b is injected by injection molding, as shown in FIG. 11, a so-called housing-less ignition coil 100 whereby a case of the ignition coil 100 is constituted of the resin compact 20a is produced. Such a housing-less ignition coil 100 realizes downsizing, cost reduction, and man-hour reduction of the ignition coil 100 by virtue of the absence of the housing 10, compared to the above-described ignition coil 100 having the housing 10. Additionally, it is more preferable to dispose the ignition coil 100 in the furnace 200 after the injection molding, and then to reliably impregnate the precursor 20b into the secondary winding 117 by carrying out the pressurizing process of 2 to 8 MPa.

Furthermore, in the injection molding, the following method may be adopted. The nozzle 202 may be made movable, and the cast molding process may be started with the nozzle 202 put into the housing 10. After that, the cast molding of the precursor 20b is complete, moving the nozzle 202 in a direction in which it recedes from the housing 10.

Also, a method whereby the precursor 20b is pressurized using a plunger or the like after the precursor 20b is injected into the above-described forming die may be adopted. By employing such a pressurizing process, the precursor 20b having relatively high viscosity is reliably impregnated between the lines of the secondary winding 117 and the like.

### Other Embodiments

One embodiment of the present invention is described above. Nevertheless, the present invention is not interpreted by limiting the invention to the above embodiment, and may be applied to various embodiments without departing from the scope of the invention.

In the above-described embodiment, the filler is made of spherical silica alone. However, as described above, the filler may include 40 weight percent crushed silica or less, and furthermore, a filler in which alumina, glass, sand and the like are mixed in the spherical silica may be included in the resin material 20.

In addition, it is preferable to include a surface active agent having many organic functions in the resin material 20 besides the filler, for improving the moisture of the resin material 20 and the filler.

Such changes and modifications are to be understood as being within the scope of the present invention as defined by the appended claims.

What is claimed is:

1. A method for making an ignition coil for an internal combustion engine, wherein the ignition coil includes:
a primary coil formed by winding a primary winding a plurality of turns;
a secondary coil formed by winding a secondary winding having a wire diameter of 30 to 100 μm a plurality of turns; and
a resin compact which is impregnated into between lines of the primary winding and between lines of the secondary winding so as to seal the primary coil and the secondary coil, the resin compact including a filler in a range of 65 weight percent to 80 weight percent, the method comprising:
a decompressing process for putting an inside of an accommodating body accommodating the primary coil and the secondary coil into a state of lower pressure than an atmospheric pressure;
a cast molding process for sealing the primary coil and the secondary coil with a precursor of the resin compact; and
a pressurizing process for pressurizing the precursor.

2. The method for making the ignition coil for the engine according to claim 1, wherein:
the filler includes spherical silica and crushed silica; and
the filler includes 60 weight percent or more spherical silica and 40 weight percent or less crushed silica.

3. The method for making the ignition coil for the engine according to claim 1, wherein the inside of the accommodating body is pressurized at a pressure range of 2 MPa to 8 MPa in the pressurizing process.

4. The method for making the ignition coil for the engine according to claim 1, wherein a linear expansion coefficient of the resin compact is 10×10⁻⁶ to 27×10⁻⁶/° C.
